(19) United States
(12) Patent Application Publication
(10) Pub. No.: US 2012/0286623 A1
(43) Pub. Date: Nov. 15, 2012

(54) Atmospheric Energy Collection

(75) Inventor: Mark E. Ogram, Tucson, AZ (US)

(73) Assignee: Sefe, Inc., Tempe, AZ (US)

(21) Appl. No.: 13/103,963

(22) Filed: May 9, 2011

(51) Int. Cl. H02N 3/00

(52) U.S. Cl. 310/309

(57) ABSTRACT

The subject matter described herein is an atmospheric energy collector. The atmospheric energy collector includes of a windsock arrangement that has a large up-wind opening on one side and that tapers from the larger up-wind opening on the one side to a small down-wind opening on the other side. The up-wind side is secured to a tether such that an electrically conducting material (e.g. metal) included in construction of the atmospheric energy collector is connected to the tether. The windsock arrangement is extended outwards by wind and the like atmospheric conditions such that the electrically conducting material collects the atmospheric energy and transfers the collected energy to the tether.

### TECHNICAL FIELD

The subject matter described herein relates to a light-weight, extendible electricity collecting windsock arrangement comprising an enhanced collection surface for atmospheric electrical energy collection.

### BACKGROUND

The atmosphere above the earth is known to include electrical charge. The earth's surface is negatively charged, while the air above it is positively charged. All atmospheric effects are a result of an interplay between these two huge areas of opposite electrical energy. The potential difference between the positively charged atmosphere and the negatively charged earth surface causes atmospheric electrical energy to be developed. Some of this atmospheric electrical energy may be experienced through thunderstorms.

Even though there is a huge amount of atmospheric electrical energy in the atmosphere, collection of the atmospheric electrical energy still remains a problem. Due to high voltage and low current conditions, there is a need for large collection surfaces for maximizing the collection of atmospheric electrical energy. Note that the terms atmospheric electricity, atmospheric energy, and atmospheric electrical energy have been used interchangeably in this specification.

The problem of low current is compounded by a heavy weight of the collectors of atmospheric electrical energy. The heavy weight of the collectors increases payload requirements of a lift mechanism, which may be used to lift the collectors to an appropriate height or altitude so that the collection of atmospheric electrical energy is maximized. Thus, a need exists for large yet light-weight collectors such that payload requirements for the lift mechanism remain reasonable.

### SUMMARY

The subject matter described herein relates to an atmospheric energy collector. The atmospheric energy collector includes an electricity collecting windsock arrangement that has a large up-wind opening on one side and that tapers from the larger up-wind opening on the one side to a small down-wind opening on the other side. The up-wind side is secured to a tether such that an electrically conducting material (e.g. metal) included in construction of the atmospheric energy collector is connected to the tether. The electricity collecting windsock arrangement is extended outwards by wind and the like atmospheric conditions such that the electrically conducting material collects the atmospheric energy and transfers the collected energy to the tether. Further, the electricity collecting windsock includes light-weight collectors such that payload requirements for the lift mechanism remain reasonable (i.e. remain within a predetermined value).

In one aspect, an electricity collection apparatus includes a tether and a windsock. The windsock is formed of an insulation material with a metal deposited on at least a portion of the insulation material. The metal of the windsock is electrically connected to the tether. The windsock extends in a direction of ambient wind to provide a surface area based on the ambient wind, and the surface area provides the metal to collect electrical energy from the ambient wind, the collected electrical energy being transferred to the tether.

In another aspect, an electricity collection apparatus includes a windsock formed of an insulation material the windsock to extend in a direction of ambient wind to provide a surface area based on the ambient wind. The apparatus further includes one or more electrical conductors provided on at least a portion of the insulation material to collect electrical energy from the ambient wind. The apparatus further includes an electrically conductive tether connected with windsock to anchor the windsock in the direction of the ambient wind, the electrically conductive tether being electrically connected to the one or more electrical conductors provided on at least a portion of the insulation material to transfer the collected electrical energy from the one or more electrical conductors to an electrical storage.

The subject matter described herein provides many advantages. For example, large collection surfaces allow a maximized collection of atmospheric energy. Moreover, the light-weight collectors allow payload requirements for the lift mechanism to remain reasonable (i.e. remain within a predetermined value).

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1A illustrates extendible electricity collecting windsock arrangement that is used for collection of atmospheric electrical energy in accordance with implementations of the current subject matter;

FIG. 1B illustrates a cross-section of one implementation of the electrically conducting windsock in accordance with implementations of the current subject matter;

FIG. 1C illustrates a cross-section of another implementation of the electricity collecting windsock in accordance with implementations of the current subject matter;

FIG. 2 illustrates an exemplary conductive line in accordance with implementations of the current subject matter;

FIG. 3A illustrates a front view of a conductive line in accordance with implementations of the current subject matter;

FIG. 3B illustrates a top view of the conductive line shown in FIG. 3 in accordance with implementations of the current subject matter;

FIGS. 4A, 4B, and 4C illustrate electrical schematics for handling the static charge from the atmosphere in accordance with implementations of the current subject matter;

FIG. 5 illustrates an adjusting apparatus (winch motor and spool) that enables adjustment of location/height of the electricity collecting windsock arrangement in accordance with implementations of the current subject matter; and

FIG. 6 is a process flow diagram illustrating aspects of a method in accordance with implementations of the current subject matter.

When practical, similar reference numbers denote similar structures, features, or elements.

### DETAILED DESCRIPTION

To address these and potentially other issues with currently available solutions, one or more implementations of the current subject matter provide methods, systems, articles or manufacture, and the like that can, among other possible advantages, provide an energy collector formed as a windsock and having an enhanced collection surface for atmospheric electrical energy collection. In preferred implementations, an electricity collecting windsock is formed as a flexible cylinder, a truncated cone, or a cone with a metal surface, and is mounted to a mast or other tether so as to capture ambient wind which extends the windsock outward from the mast, in turn forming the largest possible surface area for the wind conditions to enable the metal surface to collect atmospheric amperage. The collected amperage is transferred from the metal surface of the electricity collecting windsock to the mast or tether, and eventually to an electricity storage device. Although implementations in which windsock arrangements having one windsock each are discussed below, those or ordinary skill in the art understand that a windsock arrangement may include two or more windsocks for enhanced atmospheric electricity collection.

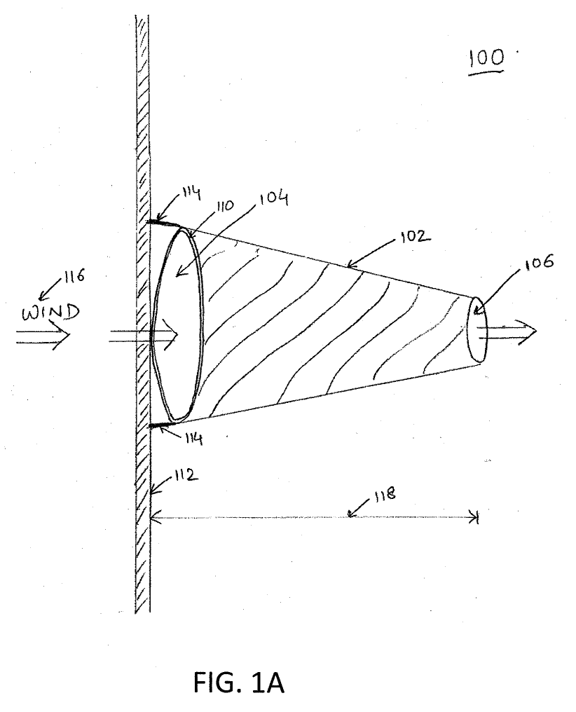

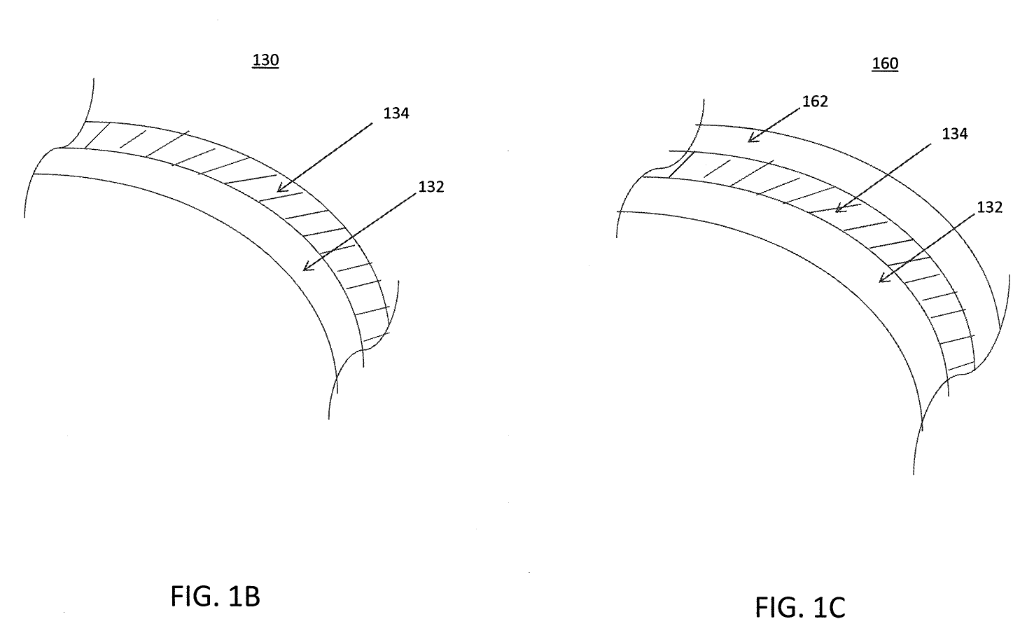

FIG. 1A illustrates an implementation of electricity collecting windsock arrangement 100 that is used to collect atmospheric electrical energy. The electricity collecting windsock arrangement 100 includes an extendible electricity collecting windsock 102. The extendible electricity collecting windsock 102 is made of a material that has a high tensile strength and provides electrical insulation. This electrically insulating material 134 (discussed below with respect to FIG. 1B) may be a plastic or a flexible glass, such as polyester like polyethylene terephthalate (PET) or biaxially-oriented polyethylene terephthalate (BoPET). BoPET is known in the industry by different trade names, some of which are Mylar, Melinex and Hostaphan.

As is described later with respect to FIGS. 1B and 1C, which illustrate cross-sections of implementations of electricity collecting windsock 102, a thin coat of an electrically conducting material 132, 162 is deposited on the electrically insulating material 134. The deposited electrically conducting material 132, 162 is a good conductor of electricity, and helps electricity collecting windsock 102 to tap atmospheric electrical energy. The electrically conducting material may be any one of a metal or a suitable alloy, such as one of or a combination of one or more of gold, silver, copper, aluminum, and the like.

The electricity collecting windsock 102 has a large up-wind opening up-wind opening 104 on one side. The electricity collecting windsock 102 tapers from the large up-wind opening 104 on the one side to a small down-wind opening 106 on the other side of the electricity collecting windsock 102. The up-wind opening 104 has a metal loop 110 on the circumference of the up-wind opening 104. The metal loop 110 is attached to a tether 112 using an attachment mechanism 114. The attachment mechanism 114 may include a soldering mechanism. In some implementations, other attachment mechanisms 114 are also known to be used, such as nut and bolt mechanism, threading mechanism, gluing mechanism, and the like. The electricity collecting windsock 102 is extended outwards by wind 116 and/or like atmospheric conditions such that the electrically conducting material (e.g. metal) collects the atmospheric electrical energy and transfers the collected energy to the tether 112.

The tether 112 includes a conductive line that is isolated from the ground. The conductive line is used to transfer the collected atmospheric electrical energy from the electricity collecting windsock 102 to an electricity storage device (not shown) where the collected atmospheric charge may be gathered for later or simultaneous use.

When wind 116 strikes against the electricity collecting windsock arrangement 100 in the direction illustrated, the electricity collecting windsock 102 extends outward, thus allowing the electrically conducting material 132 (discussed below with respect to FIG. 1B) to collect maximum possible atmospheric electricity. In one implementation, the outward extension 118 is fifty feet or more. When there is no wind, the electricity collecting windsock 102 may be in a relatively compressed state such that the length of the electricity collecting windsock 102 is less than the outward extension 118 caused by windy conditions or like atmospheric conditions. The collected atmospheric electrical energy is communicated to the tether 112.

FIG. 1B illustrates a cross-section 130 of one implementation of the electrically conducting windsock 102. The cross-section 130 illustrates the electrically conducting material 132 deposited on the inner surface of the electrically insulating material 134. The electricity collecting windsock 102 includes the electrically conducting material 132 and the electrically insulating material 134 such that the electrically conducting material 132 forms the inner surface of the electricity collecting windsock 102. When the wind 116 strikes the electricity collecting windsock arrangement, the electricity collecting windsock 102 extends outward, thus allowing the electrically conducting material 132 to collect maximum possible atmospheric electricity. The electrically conducting material 132 may include multiple collectors that are spaced apart such that the collection surface is greatly enhanced. The multiple collectors may be spaced apart in patterns, such as spaced apart lines, squares, rectangles, circles, and the like, or any other pattern that may maximize the collection of the atmospheric electrical energy. As noted above, the electrically insulating material 134 may be a plastic or a flexible glass, such as polyester like polyethylene terephthalate (PET) or biaxially-oriented polyethylene terephthalate (BoPET). The electrically conducting material 132 may be a metal or alloy, such as one of or a combination of one or more of gold, silver, copper, aluminum, and the like.

FIG. 1C illustrates a cross-section 160 of another implementation of the electricity collecting windsock 102. The electrically conducting material (e.g. metal deposit) 132, 162 may be placed on both sides of the electrically insulating material 134 such that the collection ability is increased even further. Multiple collectors are implemented and are spaced apart on electrically conducting material 132, 162 such that the collection surface is greatly enhanced. The multiple collectors may form one or more patterns, as noted above with respect to FIG. 1B. Furthermore, the electrically insulating material 134 (e.g. mylar) used in the electricity collecting windsock 102 is light, thereby minimizing the overall weight of the electricity collecting windsock 102 and reducing the weight for payload calculations. The electrically conducting materials 132, 162 may be an electrically conducting metal or alloy, such as one of or a combination of at least one of gold, copper, aluminum, silver, and the like. The electrically conducting materials 132, 162 may be made of the same metal/alloy or a different metal/alloy.

The electrically conducting materials 132, 162 may be attached to the electrically insulating material 134 by a gluing mechanism. In some implementations, other attachment mechanisms are known to be implemented, such as paint coating mechanism, a threading mechanism, a nut and bolt mechanism, soldering mechanism, and the like. The attachment mechanism between the electrically conducting material 132 and the electrically insulating material 134 may or may not be the same as the attachment mechanism between the electrically conducting material 162 and the electrically insulating material 134.

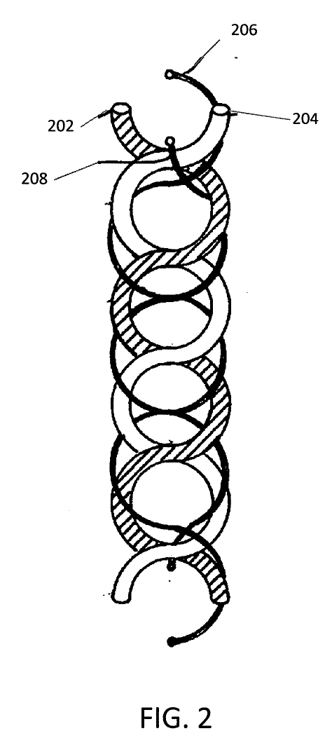

FIG. 2 illustrates an exemplary conductive line in accordance with one implementation. This type of conductive line is commonly referred to as poly-wire. The conductive line consists of multiple interwoven strands of plastic 202 and 204 woven into a cord or rope arrangement having intertwined therein exposed metal wires 206 and 208. Although FIG. 2 illustrates two plastic strands and two metal wires, any number of possible combinations of plastic strands and metal wires is possible. The exposed metal wires 206 and 208 attract the atmospheric static charge and transmit the charge down to the electricity storage device (not shown).

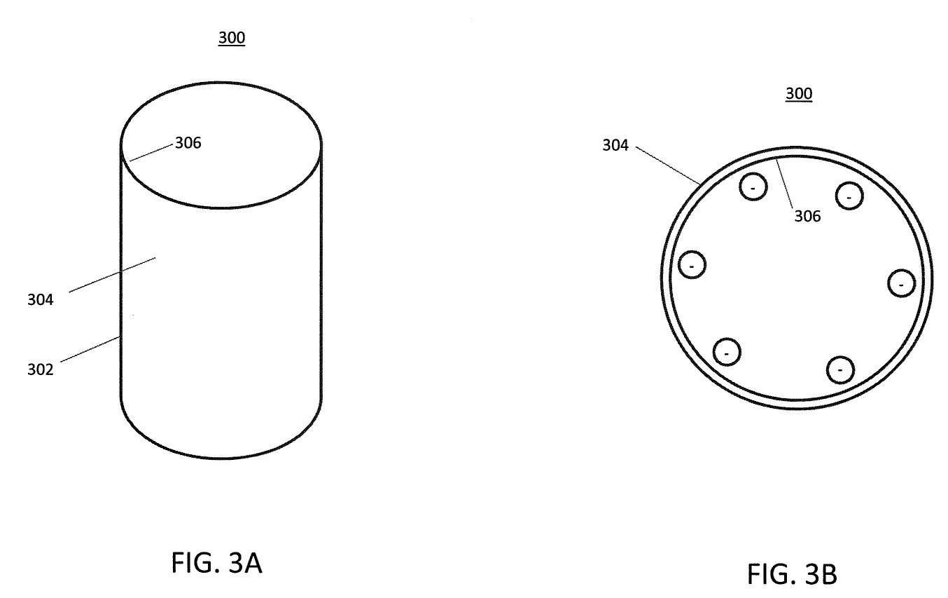

FIG. 3A illustrates a front view of a conductive line 300 in accordance with another implementation. FIG. 3B illustrates a top view of the conductive line 300 illustrated in FIG. 3. The conductive line 300 creates an ionized pathway for the flow of the static charges from the atmosphere to the electricity storage device via the electricity collecting windsock arrangement 100. This conductive line utilizes a tube 302 having an outer layer 304 of PET Film (Biaxially-oriented polyethylene terephtalate polyester film). The tube 302 provides exceptionally high tensile strength and is chemically and dimensionally stable. In one implementation, the tube 302 may have an ideal diameter of between two and three inches. An interior metal coating 306 provides an initial conduit for the flow of static charge. The static charge through the metal may force the tube 302 to expand due to the repulsion experienced by like charges. Further, the flow of electricity causes the interior of the tube 302 to become ionized to provide an additional pathway for the atmospheric static charges to the electricity storage device (not shown).

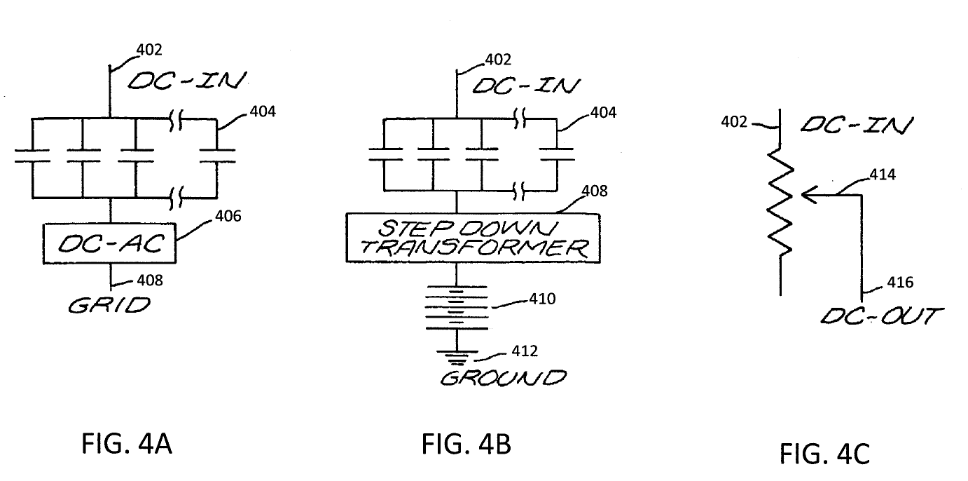

FIGS. 4A, 4B, and 4C illustrate electrical schematics for handling the static charge from the atmosphere. By maintaining the voltage being collected in a prescribed range, an electrical conversion system is easily designed. While FIGS. 4A, 4B, and 4C illustrate some electrical configurations, those of ordinary skill in the art readily recognize a variety of other configurations that may serve the same function.

Referencing FIG. 4A, Direct Current In (DC IN) 402 is buffered by a gang of capacitors 404 before being communicated to a DC/AC converter 406. The DC/AC converter converts the direct current into alternating current suitable for placement over an existing electrical grid 408 such as normally found from a power-plant. Those of ordinary skill in the art readily recognize a variety of DC/AC converters that may work in this capacity.

FIG. 4B illustrates an electrical arrangement suitable for use in charging a battery. DC IN 402 is buffered by capacitor bank 404 before entering into a step down transformer 408. Step down transformer 408 reduces the voltage so that the voltage can safely be introduced into battery 410, which is connected to ground 412 at the battery's other pole. Those of ordinary skill in the art readily recognize a variety of batteries that may work in this capacity.

In FIG. 4C, DC IN 402 is fed into an adjustable rheostat 414, which is controlled by the controller so that the DC OUT 416 falls within a specified range.

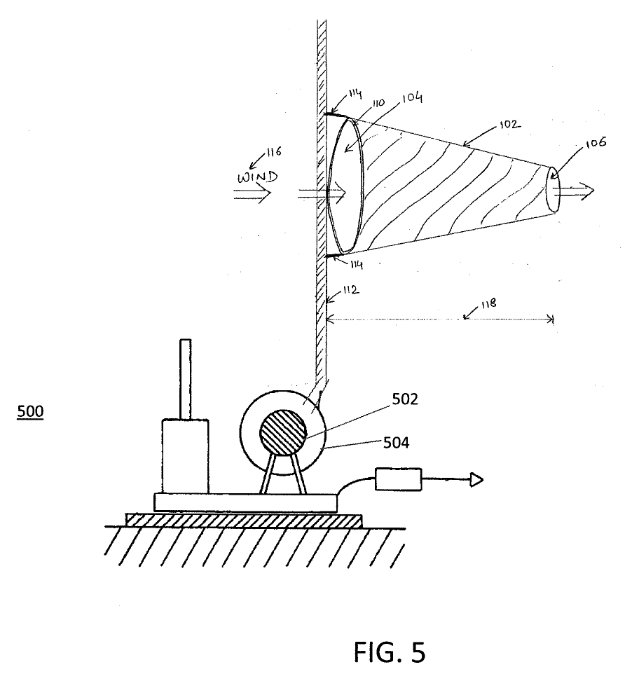

FIG. 5 illustrates an adjusting apparatus 500 that enables adjustment of height of the electricity collecting windsock arrangement 100 in accordance with one implementation. As per one implementation, the height of the electricity collecting windsock 102 can be adjusted using a winch motor 502 and a spool 504. The winch motor 502 and the spool 504 can release or withdraw the tether 112 to adjust the height of the electricity collecting windsock 102 that is connected to the tether 112. In one implementation, this release and the withdrawal may be performed manually. In another implementation, this release and the withdrawal may be performed automatically based on information obtained from a sensor system that measures atmospheric electrical energy being collected per unit time. If the sensor indicates that a current flow is diminishing, then the tether 112 is released/extended from the spool 504 to increase the altitude of the electricity collecting windsock 102 such that more static charge from the atmosphere is gathered. If the sensor indicates that collected atmospheric electrical energy exceeds a preset level per unit time, the tether 112 is withdrawn onto the spool 504 to decrease the static charge being collected from the atmosphere.

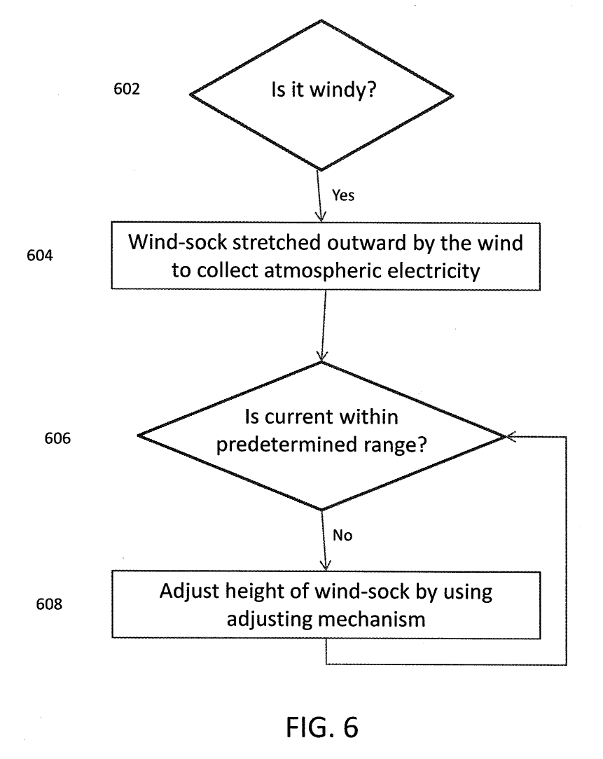

FIG. 6 is a process flow diagram illustrating aspects of a method consistent with implementations of the current subject matter. At step 602, the functioning of the electricity collecting windsock arrangement 100 depends on whether atmospheric conditions are windy. If the atmospheric conditions are windy, the wind 116 stretches/extends outward the electricity collecting windsock 102—Step 604. Next, it is determined whether the atmospheric electrical energy (atmospheric current) that is collected is in a predetermined range—Step 606. If the collected atmospheric electrical energy is in the predetermined range, the flow goes back to step 604. If the current is not in the predetermined range, the height of the electricity collecting windsock 102 may be adjusted using adjusting apparatus 500, such as the winch motor 502 and spool 504. One skilled in the art understands that other implementations may include any other adjusting apparatus 500, such as a pulley, a wheel mechanism, or the like.

The implementations set forth in the foregoing description do not represent all implementations consistent with the subject matter described herein. Instead, they are merely some examples consistent with aspects related to the described subject matter. Although a few variations have been described in detail herein, other modifications or additions are possible. In particular, further features and/or variations can be provided in addition to those set forth herein. For example, the implementations described above can be directed to various combinations and sub-combinations of the disclosed features and/or combinations and sub-combinations of one or more features further to those disclosed herein. In addition, the logic flows depicted in the accompanying figures and/or described herein do not necessarily require the particular order shown, or sequential order, to achieve desirable results. The scope of the following claims may include other implementations or embodiments.

What is claimed is:

1. An electricity collection apparatus comprising:
a tether; and
a windsock formed of an insulation material with a metal deposited on at least a portion of the insulation material, the metal of the windsock being electrically connected to the tether, the windsock to extend in a direction of ambient wind to provide a surface area based on the ambient wind, the surface area providing the metal to collect electrical energy from the ambient wind, the collected electrical energy being transferred to the tether.

2. The apparatus in accordance with claim 1, wherein the metal is deposited on at least one of opposite sides of the insulation material.

3. The apparatus in accordance with claim 2, wherein the metal is a metal selected from a group of metals comprising gold, silver, copper and aluminum.

4. The apparatus in accordance with claim 1, wherein the insulation material is a polyester film.

5. The apparatus in accordance with claim 1, wherein the transferred electrical energy at the tether is further transferred from the tether to an electricity storage device.

6. The apparatus in accordance with claim 1, wherein the metal comprises conductors that are light-weight thereby allowing payload requirements for adjusting the windsock to an optimum location to be within a predetermined value, the optimum location comprising a height of the windsock from ground level.

7. The apparatus in accordance with claim 6, wherein the deposited metal conductors form a pattern that maximizes the collection of the electrical energy at the optimum location.

8. An electricity collection apparatus comprising:
a windsock formed of an insulation material having a metal deposited on at least a portion of the insulation material, the windsock to extend in a direction of ambient wind to provide a surface area based on the ambient wind, the surface area providing the metal to collect electrical energy from the ambient wind; and
an electrically conductive tether connected with windsock to anchor the windsock in the direction of the ambient wind, the electrically conductive tether being electrically connected to the metal of the insulation material, the collected electrical energy being transferred to the tether.

9. The apparatus in accordance with claim 8, wherein the metal is deposited on at least one of opposite sides of the insulation material.

10. The apparatus in accordance with claim 9, wherein the metal is a metal selected from a group of metals comprising gold, silver, copper and aluminum.

11. The apparatus in accordance with claim 8, wherein the insulation material is a polyester film.

12. The apparatus in accordance with claim 8, wherein the transferred electrical energy at the tether is further transferred from the tether to an electricity storage device.

13. The apparatus in accordance with claim 8, wherein the metal comprises conductors that are light-weight thereby allowing payload requirements for adjusting the windsock to an optimum location to be within a predetermined value, the optimum location comprising a height of the windsock from ground level.

14. The apparatus in accordance with claim 13, wherein the metal conductors form a pattern that maximizes the collection of the electrical energy at the optimum location.

15. An electricity collection apparatus comprising:
a windsock formed of an insulation material the windsock to extend in a direction of ambient wind to provide a surface area based on the ambient wind;
one or more electrical conductors provided on at least a portion of the insulation material to collect electrical energy from the ambient wind; and
an electrically conductive tether connected with windsock to anchor the windsock in the direction of the ambient wind, the electrically conductive tether being electrically connected to the one or more electrical conductors provided on at least a portion of the insulation material to transfer the collected electrical energy from the one or more electrical conductors to an electrical storage.
